(19) United States
(12) Patent Application Publication
(10) Pub. No.: US 2021/0197215 A1
(43) Pub. Date: Jul. 1, 2021

(54) WATERWAY SWITCHING VALVE

(71) Applicant: Xiamen Solex High-Tech Industries Co., Ltd., Xiamen (CN)

(72) Inventors: Fangqi LIN, Xiamen (CN); Lihong HU, Xiamen (CN)

(21) Appl. No.: 17/201,766

(22) Filed: Mar. 15, 2021

Related U.S. Application Data
(63) Continuation of application No. PCT/CN2019/105636, filed on Sep. 12, 2019.

(30) Foreign Application Priority Data
Sep. 13, 2018 (CN) 201811069715.7
Sep. 13, 2018 (CN) 201821500098.7

(51) Int. Cl. B05B 1/16; B05B 1/30

(52) U.S. Cl. CPC B05B 1/1636; B05B 1/3026; B05B 1/169

(57) ABSTRACT

The present disclosure a waterway switching valve. A valve body comprises a water inlet, a first water outlet, and a second water outlet. The switching operating member is operatively connected to the switching member. The switching member is sequentially disposed with a first sealing member, a first pressure relief member, a second pressure relief member, and a second sealing member along a moving direction of the switching member. A first pressure generating cavity and a second pressure generating cavity are disposed in the valve body, and a blocking member is disposed in the valve body between the first pressure generating cavity and the second pressure generating cavity. The blocking member comprises a first flow passage and a second flow passage isolated from the first flow passage, and the first flow passage and the second flow passage are respectively in communication with the first water outlet and the second water outlet.

### RELATED APPLICATIONS

This application a continuation application of International Patent Application PCT/CN2019/105636, filed on Sep. 12, 2019, which claims priority to Chinese patent application number 201811069715.7, filed Sep. 13, 2018, and Chinese patent application number 201821500098.7, filed Sep. 13, 2018. International Patent Application PCT/CN2019/105636, Chinese patent application 201811069715.7 and Chinese patent application 201821500098.7 are incorporated herein by reference.

### FIELD OF THE DISCLOSURE

The present disclosure relates to a waterway switching device, and in particular relates to a waterway switching valve.

### BACKGROUND OF THE DISCLOSURE

In sanitary systems, a water inlet adapter is often used to supply water to multiple water outlet devices. Thus, a waterway switching valve needs to be provided, and the waterway switching valve is used to make water flow out of different water outlet devices. For typical waterway switching valves, the waterway settings are stacked up and down. To achieve a larger water flow area, valve cores of the waterway switching valves are generally large in size, which affects the economic benefits of the products that include the waterway switching valves.

### BRIEF SUMMARY OF THE DISCLOSURE

The present disclosure provides a waterway switching valve to achieve a small volume and a large flow rate.

In order to solve the aforementioned technical problems, the present disclosure provides a waterway switching valve. The waterway switching valve comprises a valve body, a switching operating member, and a switching member. The valve body comprises a water inlet, a first water outlet, and a second water outlet. The switching operating member is operatively connected to the switching member. The switching member is sequentially disposed with a first sealing member, a first pressure relief member, a second pressure relief member, and a second sealing member along a moving direction of the switching member. A first pressure generating cavity and a second pressure generating cavity are disposed in the valve body along the moving direction of the switching member, and a blocking member is disposed in the valve body between the first pressure generating cavity and the second pressure generating cavity. The blocking member comprises a first flow passage and a second flow passage isolated from the first flow passage, and the first flow passage and the second flow passage are respectively in communication with the first water outlet and the second water outlet. The first pressure generating cavity comprises a first opening, the second pressure generating cavity comprises a second opening, and the switching member passes through the first opening and the second opening. When the switching operating member drives the switching member to move to enable the first sealing member to correspond to the first opening of the first pressure generating cavity, the first pressure generating cavity is in a pressure suppression state, water pressure drives the first pressure generating cavity to abut and seal an upper end surface of the blocking member, and the first water outlet is isolated from the water inlet. When the switching operating member drives the switching member to move to enable the first pressure relief member to correspond to the first opening of the first pressure generating cavity, the first pressure generating cavity is in a pressure relief state, the first pressure generating cavity is separated from the upper end surface of the blocking member, and the first water outlet is in communication with the water inlet.

In a preferred embodiment, the switching member comprises a switching rod, and an axial side wall of the switching rod comprises two concave portions extending inward to define the first pressure relief member and the second pressure relief member.

In a preferred embodiment, the first water outlet and the second water outlet are disposed up and down along the moving direction of the switching member, and the water inlet is disposed between the first water outlet and the second water outlet.

In a preferred embodiment, a water inlet passage is defined between an outer wall of the blocking member and an inner wall of the valve body.

In a preferred embodiment, the first flow passage and the second flow passage are disposed up and down along the moving direction of the switching member. The blocking member comprises a mounting hole in communication with the first flow passage and the second flow passage, the switching member passes through the mounting hole, and the switching member is disposed with a third sealing member disposed between the first pressure relief member and the second pressure relief member. When the switching operating member drives the switching member to move, the third sealing member always abuts and seals the mounting hole to enable the first flow passage to be isolated from the second flow passage.

In a preferred embodiment, a side of the first pressure generating cavity facing the upper end surface of the blocking member and a side of the second pressure generating cavity facing a lower end surface of the blocking member are respectively rubber cups.

In a preferred embodiment, the rubber cups comprise pressure cavity inlet holes. The first pressure generating cavity and the second pressure generating cavity are respectively disposed with anti-blocking springs, and first ends of the anti-blocking springs are disposed in the pressure cavity inlet holes. When the first pressure generating cavity or the second pressure generating cavity is in the pressure suppression state, a corresponding one of the rubber cups moves toward the blocking member, and a corresponding one of the anti-blocking springs is stretched.

In a preferred embodiment, the valve body comprises a middle valve body base, an upper valve body base, and a lower valve body base, the upper valve body base and the lower valve body base are respectively disposed on an upper end surface and a lower end surface of the middle valve body base, and the rubber cups are disposed on the upper end surface and the lower end surface of the middle valve body base to respectively cooperate with cavities of the upper valve body base and the lower valve body base to define the first pressure generating cavity and the second pressure generating cavity.

In a preferred embodiment, the switching operating member comprises a button, a moving ratchet wheel, and a rotating ratchet wheel. A first end of the moving ratchet wheel is operatively connected to the button, and a second end of the moving ratchet wheel is disposed with a first ratchet tooth. A first end of the rotating ratchet wheel facing the moving ratchet wheel is disposed with a second ratchet tooth, and a second end of the rotating ratchet wheel faces the switching rod.

In a preferred embodiment, an indicator operatively connected to the rotating ratchet wheel. An indicator signal member is disposed on an outer periphery of the indicator.

In a preferred embodiment, the waterway switching valve comprises a housing. The valve body is disposed in the housing. A side wall of the housing is disposed with a transparent indicator window, and the indicator signal member of the indicator is disposed below the transparent indicator window. When the rotating ratchet wheel drives the indicator to rotate, the indicator signal member disposed below the transparent indicator window changes correspondingly.

Compared with the existing techniques, the technical solution has the following advantages.

1. The present disclosure provides a waterway switching valve in which only one water inlet can switch two water outlets, so the volume of the valve body is relatively small and the flow rate is relatively large.

2. The present disclosure provides a waterway switching valve, the switching rod is integrally formed with a first sealing member, a first pressure relief member, a second pressure relief member, and a second sealing member. The present disclosure has a simple structure, a compact structure, and convenient processing.

3. The present disclosure provides a waterway switching valve. The button drives the rotating ratchet wheel to rotate, and the rotating ratchet wheel drives the indicator to rotate. In this way, during the switching process, the indicator automatically rotates with the switching action, thereby changing the indicator signal member. It is convenient for users to identify the current gear position.

4. The present disclosure provides a waterway switching valve, which forms a first pressure generating cavity and a second pressure generating cavity through rubber cups installed at the upper end surface and the lower end surface of the middle value body base of the valve body respectively. It is convenient to push the switching rod to implement the waterway switching, and the structure is simple.

### BRIEF DESCRIPTION OF THE DRAWINGS

FIG. 1 illustrates a perspective view of a waterway switching valve of an embodiment of the present disclosure.

FIG. 2 illustrates an exploded perspective view of the waterway switching valve of the embodiment of the present disclosure.

FIG. 3 illustrates a view of a waterway when water flows out of a first water outlet of the waterway switching valve.

FIG. 4 illustrates a view of the waterway when water flows out of a second water outlet of the waterway switching valve.

FIG. 5 illustrates a cross-sectional view of the waterway switching valve after a housing is disposed on the waterway switching valve.

FIG. 6 illustrates a perspective view of the housing shown in FIG. 5.

FIG. 7 illustrates an exploded perspective view of a button and an indicator shown in FIG. 5.

### DETAILED DESCRIPTION OF THE EMBODIMENTS

The present disclosure will be further described below in combination with the accompanying drawings and embodiments. However, a waterway switching valve of the present disclosure is not limited to the embodiments.

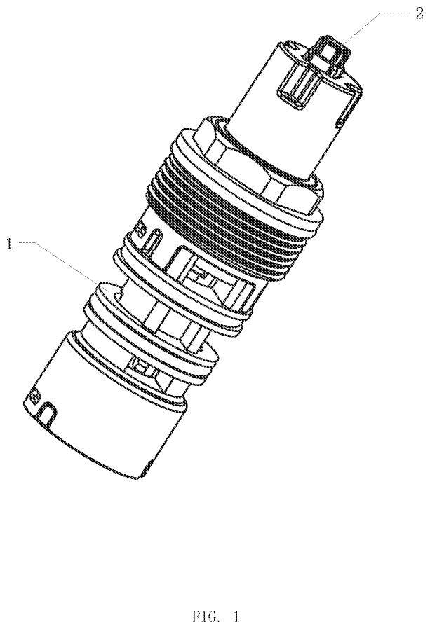

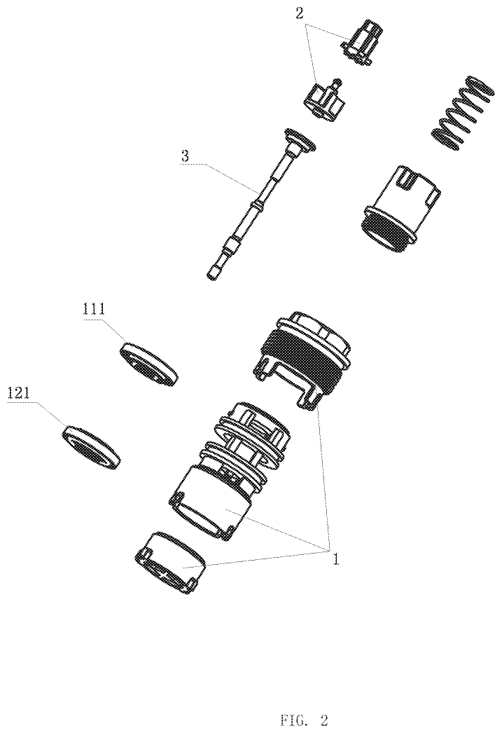

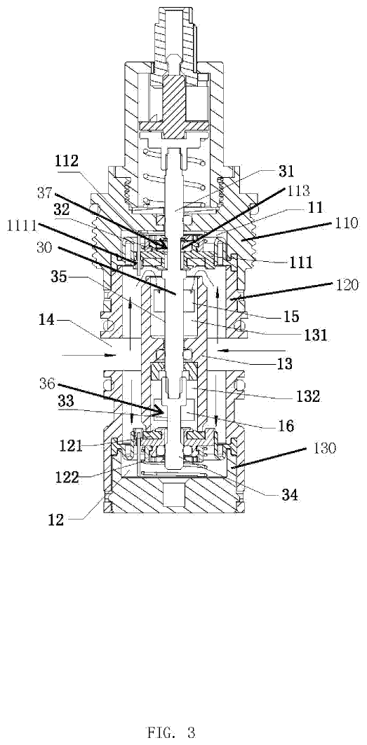

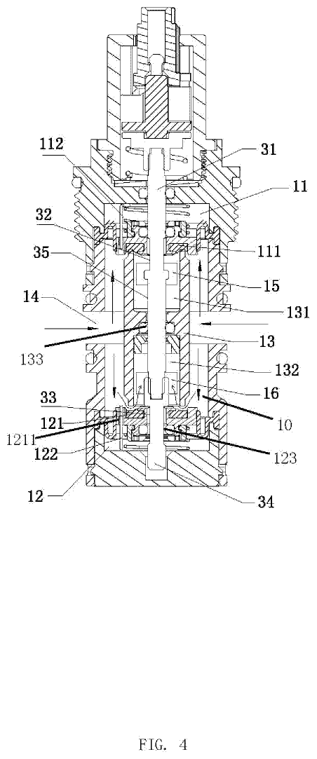

Referring to FIGS. 1-4, the waterway switching valve comprises a valve body 1, a switching operating member 2, and a switching member 3.

The valve body 1 comprises a water inlet 14, a first water outlet 15, and a second water outlet 16. The switching operating member 2 is operatively connected to the switching member 3, and the switching member 3 is sequentially disposed with a first sealing member 31, a first pressure relief member 32, a second pressure relief member 33, and a second sealing member 34 along a moving direction of the switching member 3.

A first pressure generating cavity 11 and a second pressure generating cavity 12 are disposed in the valve body 1 along the moving direction of the switching member 3. A blocking member 13 is disposed in the valve body 1 between the first pressure generating cavity 11 and the second pressure generating cavity 12. The blocking member 13 comprises a first flow passage 131 and a second flow passage 132 isolated from the first flow passage 131, and the first flow passage 131 and the second flow passage 132 are respectively in communication with the first water outlet 15 and the second water outlet 16.

The first pressure generating cavity 11 comprises a first opening 113, the second pressure generating cavity 12 comprises a second opening 123, and the switching member 3 passes through the first opening 113 and the second opening 123.

Therefore, in the waterway switching valve, the switching operating member 2 drives the switching member 3 to move. When the switching operating member 2 drives the switching member 3 to move to enable the first sealing member 31 to correspond to the first opening 113 of the first pressure generating cavity 11, the first pressure generating cavity 11 is in a pressure suppression state, water pressure drives the first pressure generating cavity 11 to abut and seal an upper end surface of the blocking member 13, and the first water outlet 15 is isolated from the water inlet 14. When the switching operating member 2 drives the switching member 3 to move to enable the first pressure relief member 32 to correspond to the first opening 113 of the first pressure generating cavity 11, the first pressure generating cavity 11 is in a pressure relief state, the first pressure generating cavity 11 is separated from the upper end surface of the blocking member 13, and the first water outlet 15 is in communication with the water inlet 14.

The waterway switching valve can be designed such that when the first water outlet 15 is in communication with the water inlet 14, the second sealing member 34 seals the second opening 123 of the second pressure generating cavity 12, so that the second water outlet 16 is isolated from the water inlet 14. In contrast, when the first water outlet 15 is isolated from the water inlet 14, the second pressure relief member 33 corresponds to the second opening 123 of the second pressure generating cavity 12, so that the second water outlet 16 is in communication with the water inlet 14. That is, the waterway switching valve comprises two water outlet states in total, and water flows out of merely one water outlet of the first water outlet 15 and the second water outlet 16. The waterway switching valve comprises two water discharging gear positions.

It is self-evident that as a simple replacement of the aforementioned structure, in another embodiment, the waterway switching valve comprises two additional water discharging gear positions in which the water flows out of the first water outlet 15 and the second water outlet 16 concurrently or no water flows out of the first water outlet 15 and the second water outlet 16 concurrently, so as to enable the waterway switching valve to comprise three or four water discharging gear positions.

In this embodiment, the switching member 3 comprises a switching rod 30, and an axial side wall of the switching rod 30 comprises two concave portions 36 and 37 extending inward, so that first parts of the switching rod 30 have large diameters, second parts of the switching rod 30 have small diameters, and the large diameters are larger than the small diameters. The first parts having the large diameters define the first sealing member 31 and the second sealing member 34, and the second parts having the small diameters define the first pressure relief member 32 and the second pressure relief member 33. The first opening 113 and the second opening 123 can be blocked or opened due to different thicknesses of different positions of the switching rod 30.

A structure of the valve body 1 will be further described below. The first water outlet 15 and the second water outlet 16 are disposed up and down (i.e., in a vertical direction) along the moving direction of the switching member 3. The water inlet 14 is disposed between the first water outlet 15 and the second water outlet 16.

A water inlet passage 10 is defined between an outer wall of the blocking member 13 and an inner wall of the valve body 1. In this way, after the water from the water inlet 14 flows into the valve body 1 and hits the outer wall of the blocking member 13, the water is divided into two streams that respectively flows upward or downward along the outer wall of the blocking member 13.

The first flow passage 131 and the second flow passage 132 are disposed up and down along the moving direction of the switching member 3. The blocking member 13 further comprises a mounting hole 133 in communication with the first flow passage 131 and the second flow passage 132. The switching member 3 passes through the mounting hole 133. The switching member 3 is further disposed with a third sealing member 35 disposed between the first pressure relief member 32 and the second pressure relief member 33. When the switching operating member 2 drives the switching member 3 to move, the third sealing member 35 always abuts and seals the mounting hole 133, so that the first flow passage 131 is isolated from the second flow passage 132.

In the aforementioned arrangement, after the water from the water inlet 14 flows into the valve body 1, the water flows upward and downward along the outer wall of the blocking member 13 to end surfaces (i.e., the upper end surface and a lower end surface) of the blocking member 13. Only when the end surfaces of the blocking member 13 are open does the water flow into the first flow passage 131 or the second flow passage 132. Therefore, as long as the end surfaces of the blocking member 13 are sealed, the first flow passage 131 or the second flow passage 132 can be closed, and then the first water outlet 15 or the second water outlet 16 can be closed.

Therefore, a side of the first pressure generating cavity 11 facing the upper end surface of the blocking member 13 and a side of the second pressure generating cavity 12 facing the lower end surface of the blocking member 13 are respectively disposed with rubber cups 111, 121, so that when one of the first water outlet 15 or the second water outlet 16 needs to be closed, a corresponding one of the end surfaces of the blocking member 13 is sealed. When one of the first pressure generating cavity 11 or the second pressure generating cavity 12 is in the pressure suppression state, a corresponding one of the rubber cups 111 and 121 can be pushed to move close to a corresponding one of the end surfaces of the blocking member 13 due to the water pressure in the one of the first pressure generating cavity 11 or the second pressure generating cavity 12 becoming larger and larger, so that the corresponding one of the rubber cups 111, 121 and the corresponding one of the end surfaces of the blocking member 13 are closely attached.

The rubber cups 111 and 121 comprise pressure cavity inlet holes 1111 and 1211, and anti-blocking springs 112, 122 are respectively disposed in the first pressure generating cavity 11 and the second pressure generating cavity 12. First ends of the anti-blocking springs 112, 122 are disposed in the pressure cavity inlet holes 1111 and 1211, so that when the one of the first water outlet 15 or the second water outlet 16 is opened, the corresponding one of the end surfaces of the blocking member 13 is separated from the corresponding one of the rubber cups 111 and 121. When the one of the first pressure generating cavity 11 or the second pressure generating cavity 12 is in the pressure suppression state, the corresponding one of the rubber cups 111, 121 moves toward the blocking member 13, and the anti-blocking springs 112, 122 are stretched. In this way, when the one of the first pressure generating cavity 11 or the second pressure generating cavity 12 is in the pressure relief state, a reset force of the corresponding one of the anti-blocking springs 112, 122 drives the corresponding one of the rubber cups 111, 121 to move away from the corresponding one of the end surfaces of the blocking member 13, thereby the corresponding one of the rubber cups 111, 121 is separated from the corresponding one of the end surfaces of the blocking member 13.

In addition, in order to assemble the rubber cups 111 and 121, the valve body 1 comprises a middle valve body base 120, an upper valve body base 110, and a lower valve body base 130. The upper valve body base 110 and the lower valve body base 130 are respectively disposed on an upper end surface and a lower end surface of the middle valve body base 120 of the valve body 1. The rubber cups 111 and 121 are disposed on the upper end surface and the lower end surface of the middle valve body base 120 of the valve body 1 and respectively cooperate with cavities of the upper valve body base 110 and lower valve body base 130 to define the first pressure generating cavity 11 and the second pressure generating cavity 12.

In this embodiment, the switching operating member 2 comprises a button 21, a moving ratchet wheel 22, and a rotating ratchet wheel 23. A first end of the moving ratchet wheel 22 is operatively connected to the button 21, and a second end of the moving ratchet wheel 22 is disposed with a first ratchet tooth 221. A first end of the rotating ratchet wheel 23 facing the moving ratchet wheel 22 is also disposed with a second ratchet tooth 231, and a second end of the rotating ratchet wheel 23 faces the switching rod 30. When the button 21 is pressed, the button 21 pushes the moving ratchet wheel 22 to move, so that the first ratchet tooth 221 of the moving ratchet wheel 22 abuts the second ratchet tooth 231 of the rotating ratchet wheel 23 to generate an abutting force to enable the rotating ratchet wheel 23 to move away from the moving ratchet wheel 22 and to rotate a distance of the second ratchet tooth 231. When the rotating ratchet wheel 23 moves, the rotating ratchet wheel 23 abuts the switching rod 30 to drive the switching rod 30 to move along an axis of the switching rod 30.

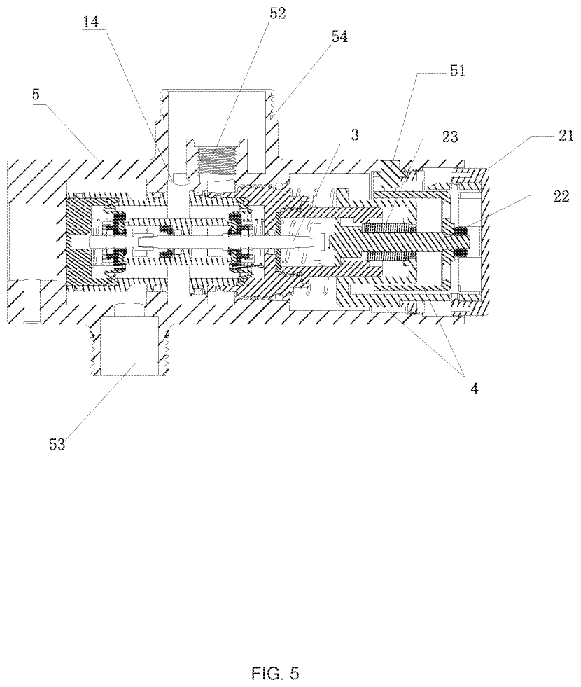

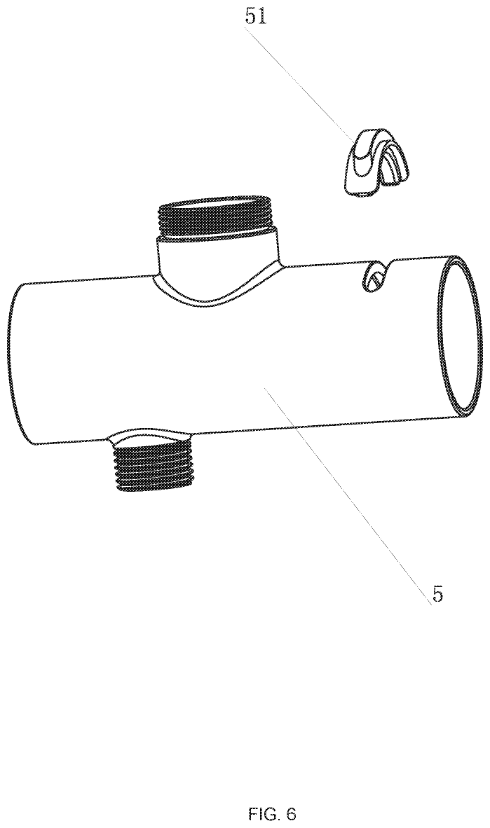

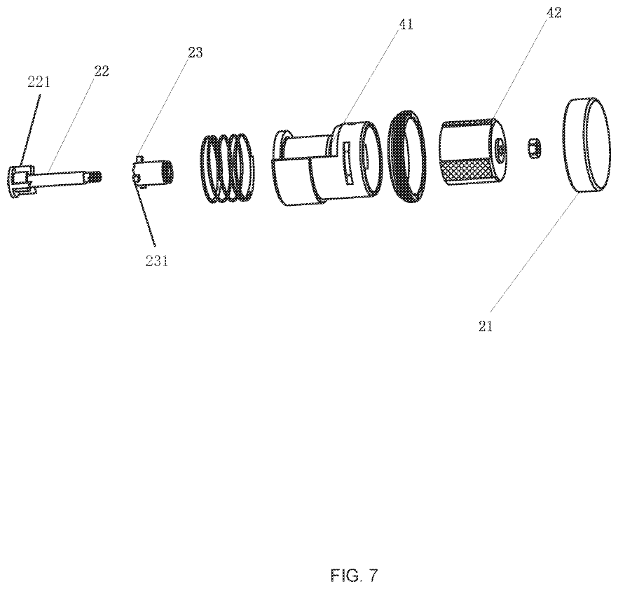

Referring to FIGS. 5-7, the waterway switching valve of the present disclosure further comprises an indicator 4 operatively connected to the rotating ratchet wheel 23 and a housing 5, so that a user clearly knows a current gear position of the waterway switching valve. The indicator 4 comprises a pressing adapter 41 and an indicator signal member 42. The pressing adapter 41 is secured to the pressing button 21 and the moving ratchet wheel 22, and the indicator signal member 42 is secured to the rotating ratchet wheel 23 (i.e., an outer periphery of the indicator 4).

The valve body 1 is disposed in the housing 5. A side wall of the housing 5 is disposed with a transparent indicator window 51, and the indicator signal member 42 is disposed below the transparent indicator window 51.

When the button 21 is pressed, the button 21 pushes the moving ratchet wheel 22 to move, so that the first ratchet tooth 221 of the moving ratchet wheel 22 abuts the second ratchet tooth 231 of the rotating ratchet wheel 23 to generate the abutting force to enable the rotating ratchet wheel 23 to move away from the moving ratchet wheel 22 and to rotate a distance of the second ratchet tooth 231. At the same time, the rotating ratchet wheel 23 drives the indicator signal member 42 to rotate correspondingly, and an indicator signal of the indicator signal member 42 disposed below the transparent indicator window 51 changes correspondingly.

In this embodiment, the housing 5 comprises a first pipe joint 54 and a second pipe joint 53. An inner side of the first pipe joint 54 is disposed with the water inlet 14 and a water outlet pipe joint 52 in communication with the first water outlet 15. The second pipe joint 53 is in communication with the second water outlet 16.

The waterway switching valve of the present disclosure can be used for waterway switching for sanitary products, as well as for waterway switching of kitchen faucets.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure by those skilled in the art.

What is claimed is:

1. A waterway switching valve, comprising:
a valve body,
a switching operating member, and
a switching member, wherein:
the valve body comprises a water inlet, a first water outlet, and a second water outlet,
the switching operating member is operatively connected to the switching member,
the switching member is sequentially disposed with a first sealing member, a first pressure relief member, a second pressure relief member, and a second sealing member along a moving direction of the switching member,
a first pressure generating cavity and a second pressure generating cavity are disposed in the valve body along the moving direction of the switching member,
a blocking member is disposed in the valve body between the first pressure generating cavity and the second pressure generating cavity,
the blocking member comprises a first flow passage and a second flow passage isolated from the first flow passage,
the first flow passage and the second flow passage are respectively in communication with the first water outlet and the second water outlet,
the first pressure generating cavity comprises a first opening,
the second pressure generating cavity comprises a second opening,
the switching member passes through the first opening and the second opening,
when the switching operating member drives the switching member to move to enable the first sealing member to correspond to the first opening of the first pressure generating cavity:
the first pressure generating cavity is in a pressure suppression state,
water pressure drives the first pressure generating cavity to abut and seal an upper end surface of the blocking member, and
the first water outlet is isolated from the water inlet, and
when the switching operating member drives the switching member to move to enable the first pressure relief member to correspond to the first opening of the first pressure generating cavity:
the first pressure generating cavity is in a pressure relief state,
the first pressure generating cavity is separated from the upper end surface of the blocking member, and
the first water outlet is in communication with the water inlet.

2. The waterway switching valve according to claim 1, wherein:
the switching member comprises a switching rod, and
an axial side wall of the switching rod comprises two concave portions extending inward to define the first pressure relief member and the second pressure relief member.

3. The waterway switching valve according to claim 2, wherein:
the first water outlet and the second water outlet are disposed up and down along the moving direction of the switching member, and
the water inlet is disposed between the first water outlet and the second water outlet.

4. The waterway switching valve according to claim 3, wherein a water inlet passage is defined between an outer wall of the blocking member and an inner wall of the valve body.

5. The waterway switching valve according to claim 4, wherein:
the first flow passage and the second flow passage are disposed up and down along the moving direction of the switching member,
the blocking member comprises a mounting hole in communication with the first flow passage and the second flow passage,
the switching member passes through the mounting hole,
the switching member is disposed with a third sealing member disposed between the first pressure relief member and the second pressure relief member, and
when the switching operating member drives the switching member to move, the third sealing member always abuts and seals the mounting hole to enable the first flow passage to be isolated from the second flow passage.

6. The waterway switching valve according to claim 4, wherein a side of the first pressure generating cavity facing the upper end surface of the blocking member and a side of the second pressure generating cavity facing a lower end surface of the blocking member are respectively rubber cups.

7. The waterway switching valve according to claim 6, wherein:
the rubber cups comprise pressure cavity inlet holes,
the first pressure generating cavity and the second pressure generating cavity are respectively disposed with anti-blocking springs,
first ends of the anti-blocking springs are disposed in the pressure cavity inlet holes, and
when the first pressure generating cavity or the second pressure generating cavity is in the pressure suppression state:
a corresponding one of the rubber cups moves toward the blocking member, and
a corresponding one of the anti-blocking springs is stretched.

8. The waterway switching valve according to claim 7, wherein:
the valve body comprises a middle valve body base, an upper valve body base, and a lower valve body base,
the upper valve body base and the lower valve body base are respectively disposed on an upper end surface and a lower end surface of the middle valve body base, and
the rubber cups are disposed on the upper end surface and the lower end surface of the middle valve body base to respectively cooperate with cavities of the upper valve body base and the lower valve body base to define the first pressure generating cavity and the second pressure generating cavity.

9. The waterway switching valve according to claim 8, wherein:
the switching operating member comprises a button, a moving ratchet wheel, and a rotating ratchet wheel,
a first end of the moving ratchet wheel is operatively connected to the button,
a second end of the moving ratchet wheel is disposed with a first ratchet tooth,
a first end of the rotating ratchet wheel facing the moving ratchet wheel is disposed with a second ratchet tooth, and
a second end of the rotating ratchet wheel faces the switching rod.

10. The waterway switching valve according to claim 9, comprising:
an indicator operatively connected to the rotating ratchet wheel, wherein:
an indicator signal member is disposed on an outer periphery of the indicator.

11. The waterway switching valve according to claim 10, comprising:
a housing, wherein:
the valve body is disposed in the housing,
a side wall of the housing is disposed with a transparent indicator window,
the indicator signal member of the indicator is disposed below the transparent indicator window, and
when the rotating ratchet wheel drives the indicator to rotate, the indicator signal member disposed below the transparent indicator window changes correspondingly.

12. A waterway switching valve, comprising:
a valve body,
a switching operating member,
a switching member,
a housing, and
an indicator, wherein:
the valve body comprises a water inlet, a first water outlet, and a second water outlet,
the switching operating member is operatively connected to the switching member,
the switching member is sequentially disposed with a first sealing member, a first pressure relief member, a second pressure relief member, and a second sealing member along a moving direction of the switching member,
a first pressure generating cavity and a second pressure generating cavity are disposed in the valve body along the moving direction of the switching member,
a blocking member is disposed in the valve body between the first pressure generating cavity and the second pressure generating cavity,
the blocking member comprises a first flow passage and a second flow passage isolated from the first flow passage,
the first flow passage and the second flow passage are respectively in communication with the first water outlet and the second water outlet,
the switching operating member comprises a rotating ratchet wheel,
the valve body is disposed in the housing,
a side wall of the housing is disposed with a transparent indicator window,
an indicator signal member of the indicator is disposed below the transparent indicator window, and
when the rotating ratchet wheel drives the indicator to rotate, the indicator signal member disposed below the transparent indicator window changes correspondingly.

13. The waterway switching valve according to claim 12, wherein:
the switching member comprises a switching rod, and
an axial side wall of the switching rod comprises two concave portions extending inward to define the first pressure relief member and the second pressure relief member.
